(19) United States
(12) Patent Application Publication
(10) Pub. No.: US 2010/0084540 A1
(43) Pub. Date: Apr. 8, 2010

(54) Pocket Forming Insert

(76) Inventors: Nick Talley, Newnan, GA (US); Bobbie Don Peacock, Peachtree City, GA (US); Bobbie Don Peacock, JR., Newnan, GA (US); Bryan N. Wilmoth, Griffin, GA (US); Tom Holak, Peachtree City, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/228,101

(22) Filed: Sep. 23, 2008

(51) Int. Cl. B29C 39/34

(52) U.S. Cl. 249/1

(57) ABSTRACT

This patent application is for devices and methods for forming lifting pockets in concrete structures. In some embodiments, a lifting hook or other lifting device may engage rigid or flexible cables or other structures accessible in the pocket to facilitate movement of the concrete structure.

### SUMMARY OF EMBODIMENTS OF THE INVENTION

This patent application is for devices and methods for forming lifting pockets in concrete structures. In some embodiments, a lifting hook or other lifting device may engage rigid or flexible cables or other structures accessible in the pocket to facilitate movement of the concrete structure. The figures accompanying this application show a few, non-limiting, embodiments of pocket forming inserts. FIGS. 1 and 2 show various views of one embodiment of a pocket forming device. FIGS. 3, 4 and 5 show various views of some embodiments of pocket forming devices that include covers and/or lift cables. These drawings are only examples, however, of some of the devices and methods for forming lifting pockets within the scope of applicants' invention, and, as such, the specific proportions, measurements, features, components, etc. shown in those drawings and/or described in this application should not be viewed as limitations on the scope of the invention.

### BRIEF DESCRIPTION OF THE DRAWINGS

FIG. 1A is a top plan view of a pocket forming insert according to one embodiment of the present invention.

FIG. 1B is a cross-sectional view of the pocket forming insert of FIG. 1A taken between line A-A.

FIG. 2A is a top perspective view of the pocket forming insert of FIG. 1A.

FIG. 2B is a cross-sectional view of the pocket forming insert of FIG. 1A taken between line B-B.

FIG. 3 is a top plan view of the pocket forming insert of FIG. 1A, showing a lift cable used in the pocket forming insert.

FIG. 4 is a top perspective view of the pocket forming insert of FIG. 1A, showing a lift cable used in the pocket forming insert.

FIG. 5A is a top plan view of the pocket forming insert of FIG. 1A, showing a cover and another configuration of a lift cable used in the pocket forming insert.

FIG. 5B is a top perspective view of the pocket forming insert of FIG. 1A, showing a cover and another configuration of a lift cable used in the pocket forming insert.

### DETAILED DESCRIPTION OF EMBODIMENTS OF THE INVENTION

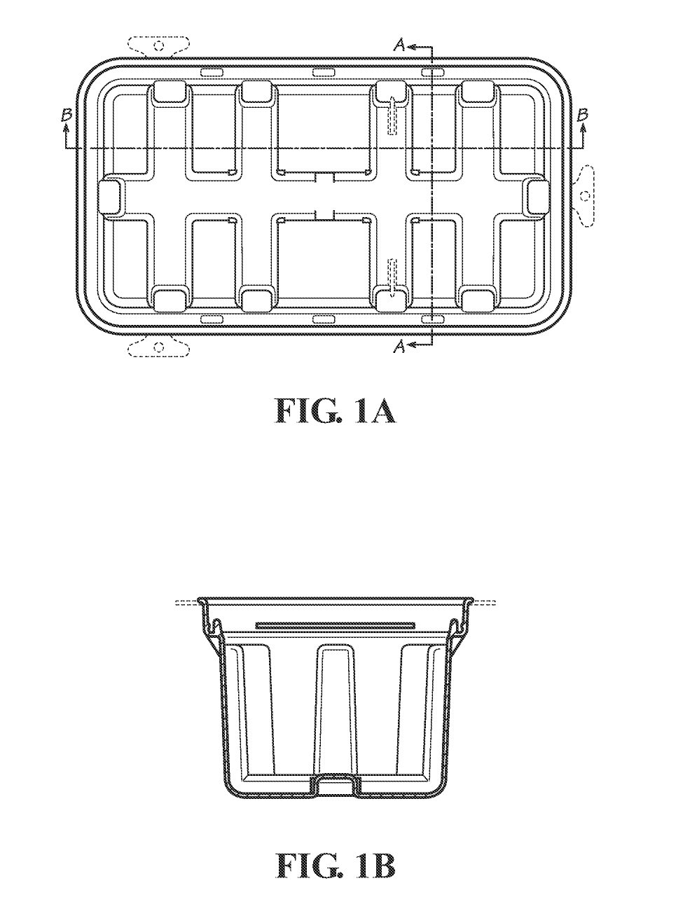

FIG. 1 shows top and side views of one example of a pocket forming device. The pocket forming device of FIG. 1 includes a pocket surrounded by side and bottom walls. In some embodiments, the size of the pocket may be appropriate for use with a number of different sized lifting hooks (i.e. a “one size fits all” type device), although, in other embodiments, the pocket forming device may be offered in various sizes for use with a specific size or sizes of hooks. The pocket may be formed from injection-molded plastic or from other materials and using other methodologies.

The side and bottom walls of the pocket may include any number of knock out points of any desired shape capable of receiving one or more lifting cables or other structures for interaction with a lifting hook or other lifting device. In some embodiments, the variety of knock out point locations may facilitate positioning a lifting cable in a variety of orientations in the pocket, depending upon the specific use for which the device is intended. In other embodiments, pre-made holes can be substituted for one or more of the knock out points.

In some embodiments, such as the embodiment shown in FIG. 1, the pocket may include features that help to position the pocket properly in the concrete structure. For instance, the pocket shown in FIG. 1 includes channels formed in the side and bottom walls. These channels, in some uses, may nest with or otherwise interact with reinforcing bars (rebar) positioned with the concrete form or other structures to facilitate positioning the pocket. The number and location of the channels in the exterior of the pocket may be variable, and is not limited to the particular number and orientations shown in the Figures. The pocket, in some embodiments, may also include tabs, which mayor may not have holes in them, which may also help position the pocket in the concrete form. For instance, the tabs could be used to nail the pocket to the wood or other material defining the edges of the concrete forms. These tabs may also receive wires for further or alternatively securing the pocket to the wood form or other structures. In still other embodiments, other methods and/or structures may be used to position the pocket in the form.

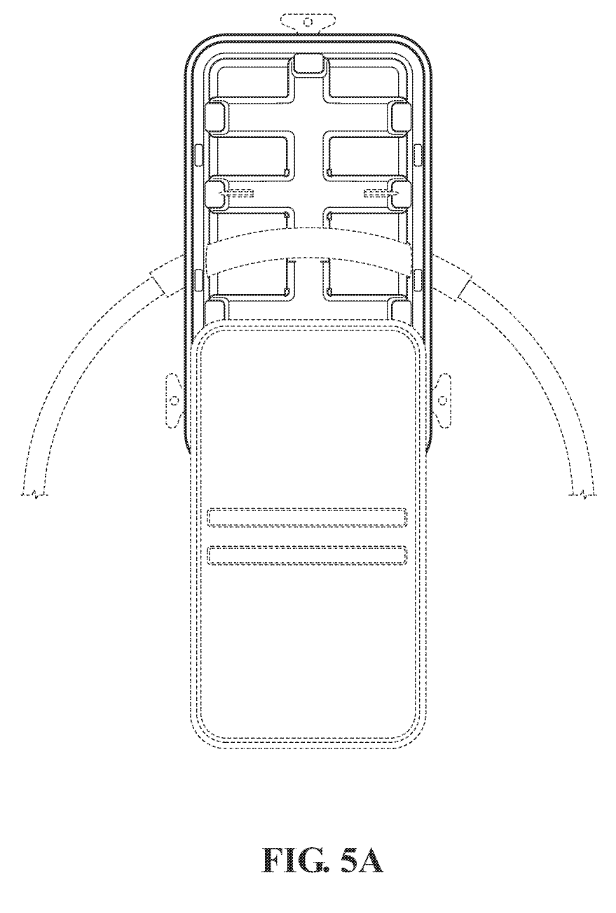

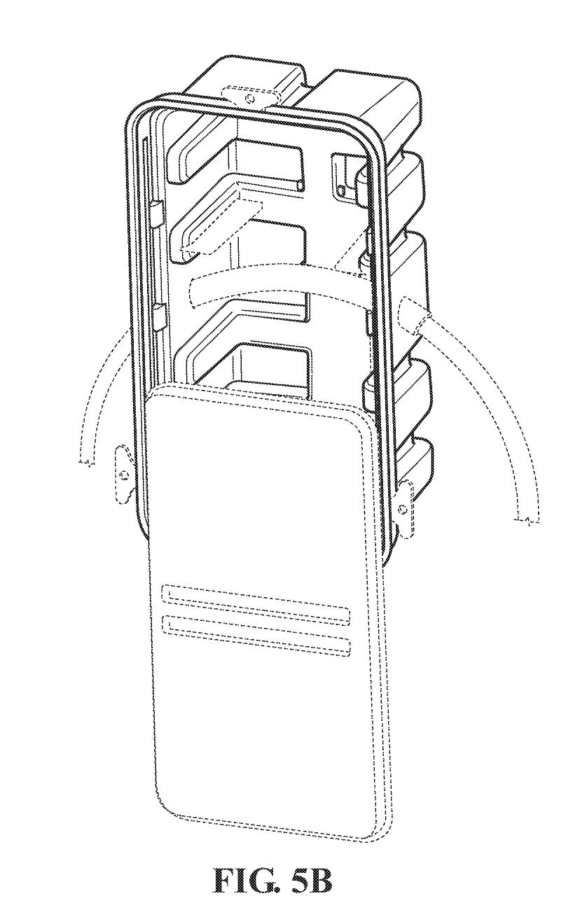

In some embodiments, the pocket may be used with a cover. In some embodiments, the cover may be removable and re-attachable. For instance, in the embodiment shown in FIG. 1, the pocket includes ridges and resilient arms positioned around the perimeter of the pocket's opening A cover (such as the covers shown in FIG. 5) may include a lip around its perimeter that will snap into the space between the ridges and the resilient arms to temporarily secure the cover over the pocket. The cover may include a handle (such as the recessed handles shown in FIG. 5 or other types of handles) to help remove the cover. Other mechanisms for securing a cover to a pocket are also envisioned.

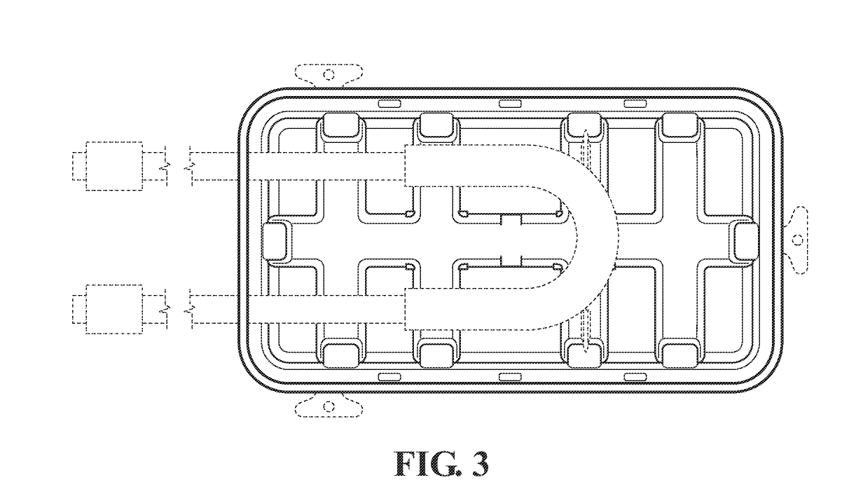

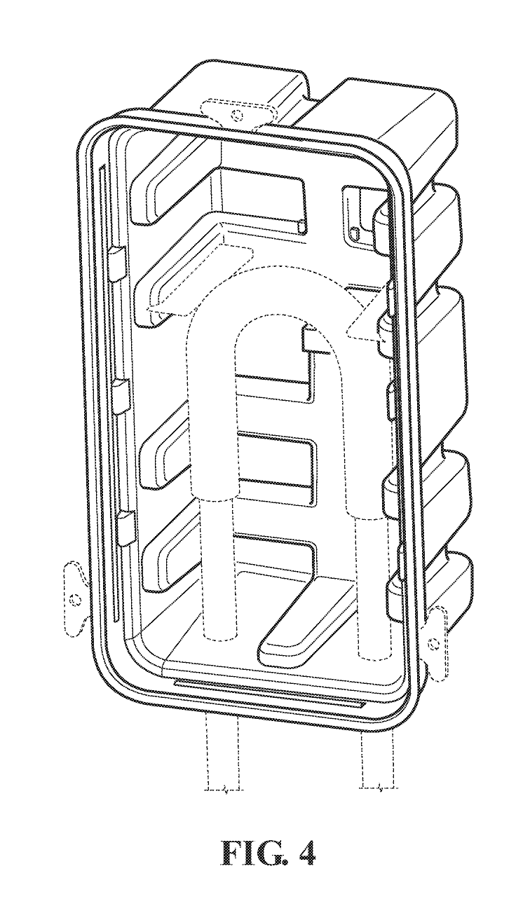

FIGS. 3 through 5 show that a flexible cable (as well as a rigid cable or other structure) can be at least partially positioned within the pocket. When the pocket is embedded in a concrete structure, a lifting hook or other device may engage the cable to help lift the concrete structure. In some embodiments, including the embodiments shown in the Figures, the cable may include a u-shaped tube proximate where the hook will engage the cable, to help reinforce the cable.

In some embodiments, the ends of the cable may extend outside of the pocket and be tied (using twisted wires or other structures) into the rebar or other supporting structure in the concrete form. In other embodiments, the cable may act as an anchor simply by extending into the concrete. As shown, the cable includes enlarged structures (such as aluminum blocks) at its ends, to further help anchor the device in the concrete. It may be desirable in some instances to coat the aluminum blocks, other structures, or other portions of the cable to prevent corrosion in use. Suitable coatings may include, but are not limited to, plasticized PVC coatings, other plastic coatings, lacquers, bituminous coatings, galvanized coatings, etc. In one, non-limiting, embodiment, the aluminum blocks may be treated with a plasticized PVC coating and the cable and associated tube may be treated with a galvanized coating. Other moisture resistant coatings may also be used.

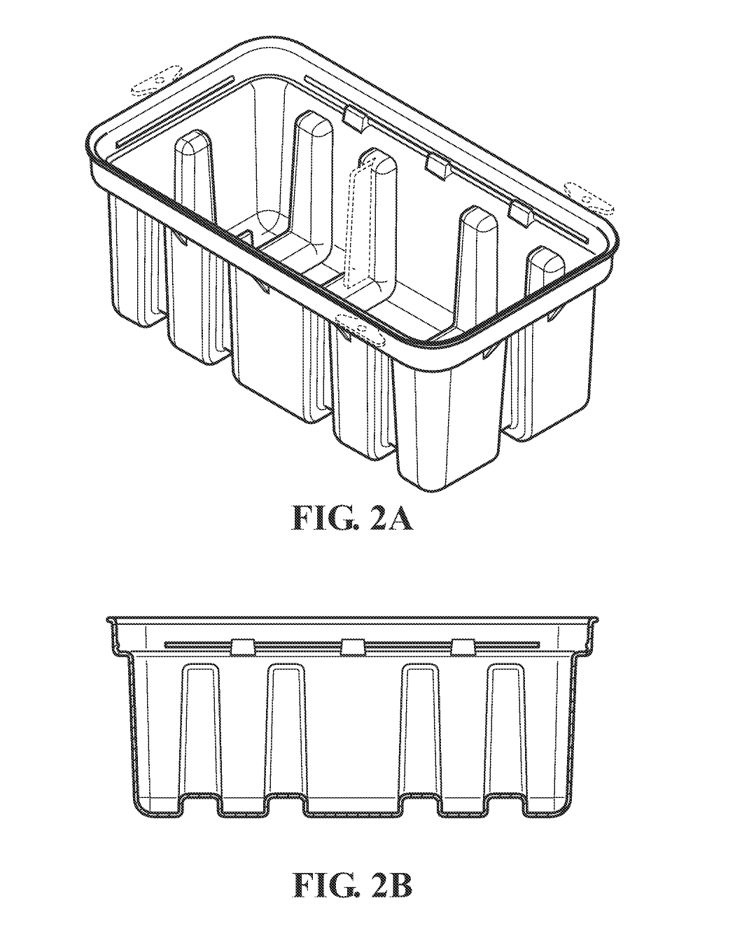

In some embodiments, it may be desirable to limit the motion of the portions of the cable positioned within the pocket. For instance, in some instances, it may be desirable to ensure that the u-shaped portion of the cable is not too close to an edge of the pocket, such that the lifting hook could come into contact with the walls of the pocket and potentially damage the pocket and/or the concrete structure. The pockets shown in FIGS. 1-4 include blades positioned to interact with the u-shaped portion of the cable and limit its movement.

Other structures, in other positions, could also be used as appropriate.

1. A pocket-forming insert comprising:
a pocket surrounded by at least one side wall and at least one bottom wall;
a plurality of channels formed in the side and bottom walls, wherein the plurality of channels nest with reinforcing bars to facilitate positioning of the pocket;
at least one aperture formed in the at least one side wall;
a cable passing through the at least one aperture of the pocket; and
a lifting hook to engage the cable.

2. The pocket-forming insert of claim 1, wherein the cable further comprises a u-shaped tube proximate the hook to reinforce the cable.
